(19) United States
(12) Patent Application Publication
(10) Pub. No.: US 2025/0262518 A1
(43) Pub. Date: Aug. 21, 2025

(54) SYSTEMS AND METHODS FOR PORTABLE AND TEMPORARY SETUP OF PLAYING COURTS

(71) Applicant: Anywhere Pickleball LLC, San Marcos, CA (US)

(72) Inventor: Angus Wong, San Marcos, CA (US)

(73) Assignee: Anywhere Pickleball LLC, San Marcos, CA (US)

(21) Appl. No.: 18/674,848

(22) Filed: May 25, 2024

Related U.S. Application Data
(60) Provisional application No. 63/554,781, filed on Feb. 16, 2024.

(51) Int. Cl. A63C 19/06; G01B 3/00

(52) U.S. Cl. CPC A63C 19/065; G01B 3/002

(57) ABSTRACT

A polar boundary marking system is disclosed. The polar boundary marking system includes a substrate having an origin and a plurality of substrate markings. A measuring cord is configured to rotatably couple to the origin. The measuring cord includes a plurality of cord markings wherein each of the plurality of cord markings is associated with one of the plurality of substrate markings. The measuring cord is configured to align with or intersect with each of the plurality of substrate markings to provide angle and distance polar coordinates related to a particular boundary line. Distance from the origin of an associated cord marking provides a radius of the polar coordinates related to the particular boundary line. Players can utilize the polar boundary marking system to quickly and easily mark boundary lines of a game court.

### CROSS-REFERENCE TO RELATED APPLICATIONS

This application claims benefit of priority with U.S. Provisional Application Ser. No. 63/554,781, filed Feb. 16, 2024; the entire contents of which are hereby incorporated by reference.

### BACKGROUND

### Field of the Invention

This disclosure relates to a systems and methods for portable and temporary setup of playing courts, and more particularly to temporary boundary lines formed by either a court boundary stencil or a polar boundary marking system.

### Description of the Related Art

Ball game sports like tennis, badminton, and pickleball require marked courts on a hard surface. While dedicated courts are ideal, access to such facilities can be limited. Players often resort to using available spaces in parks, schoolyards, gyms, parking lots or driveway to set up temporary courts with lines and portable nets. However, existing methods like masking tape, ropes, chalk, and fabric straps for marking temporary court lines are often inadequate. These methods are time-consuming to set up, susceptible to fading or dislodgement, and may not maintain accurate court dimensions, impacting gameplay and potentially creating trip hazards.

Creating a temporary ball game court, such as pickleball, can take time and effort to set up and mark out the court. Ensuring accurate lines and court size can be challenging with temporary solutions potentially affecting gameplay. USA Pickleball encourages the creation of temporary pickleball courts as a way to address the growing demand for playing spaces with the understanding that not everyone has access to permanent courts. Current solutions include the use of dozens of plastic sheets to be laid on the hard surface to resemble court lines, use adhesive tape, or adhere several fabric straps to mark the court. The methods are time consuming, inaccurate, expensive or environmental unfriendly.

Therefore, a need exists for systems and methods that can provide efficient, accurate, portable, and reusable temporary court marking system.

### SUMMARY

A court boundary stencil is disclosed. The court boundary stencil comprises a plurality of straps including a stencil periphery having a first through fourth corners wherein the first and second corners are disposed at a longitudinal upper half and the third and fourth corners are disposed at a longitudinal lower half. The stencil periphery comprises a first major side, a second major side opposite the first major side, a first minor side, and a second minor side opposite the first minor side. A first diagonal strap is coupled to the second and fourth corners. The second diagonal strap is coupled to the first and third corners. The court boundary stencil further comprises a plurality of indicators to aid players in properly mark boundary lines of a game court. The plurality of indicators includes a first upper non-volley indicator disposed on the first major side at the longitudinal upper half, a second upper non-volley indicator disposed on the second major side at the longitudinal upper half, wherein the second upper non-volley indicator and the first upper non-volley indicator are equally distanced from the first minor side, a first center indicator disposed at a midpoint of the first minor side, a first lower non-volley indicator disposed on the first major side at the longitudinal lower half, a second lower non-volley indicator disposed on the second major side at the longitudinal lower half, wherein the second lower non-volley indicator and the first lower non-volley indicator are equally distanced from the second minor side, and a second center indicator disposed at a midpoint of the second minor side.

A court boundary stencil is disclosed. The court boundary stencil comprises a plurality of straps including a stencil periphery having a first major side, a second major side opposite the first major side, a first minor side, and a second minor side opposite the first minor side. The stencil periphery further comprises a longitudinal upper half and a longitudinal lower half. A first non-volley boundary strap is coupled to each of the first major side and the second major side at the longitudinal upper half. A first center boundary strap is coupled to both a midpoint of the first minor side and a midpoint of the first non-volley boundary strap. A second non-volley boundary strap is coupled to each of the first major side and the second major side at the longitudinal lower half. A second center boundary strap is coupled to both a midpoint of the second minor side and a midpoint of the second non-volley boundary strap. A central strap is coupled to each of the midpoint of the first non-volley boundary strap and the midpoint of the second non-volley volley boundary strap. The central support strap is configured to provide proper alignment and linearity of the court boundary stencil.

A polar boundary marking system is disclosed. The polar boundary marking system comprises a substrate having an origin and a plurality of substrate markings. A measuring cord is configured to rotatably couple to the origin. The measuring cord comprises a plurality of cord markings wherein each of the plurality of cord markings is associated with at least one of the plurality of substrate markings. The measuring cord is configured to align with or intersect each of the plurality of substrate markings to provide angle and distance polar coordinates related to particular boundary line. Distance from the origin an associated cord marking provides a radius of the polar coordinates related to the particular boundary line.

### BRIEF DESCRIPTION OF THE DRAWINGS

Other features, combinations, and embodiments will be appreciated by one having the ordinary level of skill in the art upon a thorough review of the following details and descriptions, particularly when reviewed in conjunction with the drawings, wherein:

FIG. 1 shows a perspective view of conventional game court boundary lines for a game of pickleball;

FIG. 2 shows a top view of a court boundary stencil in accordance with a first illustrated embodiment;

FIG. 3 shows a top view of a court boundary stencil in accordance with a second illustrated embodiment;

FIG. 4 shows a top view of a substrate of a polar boundary marking system in accordance with a third illustrated embodiment;

FIG. 5 shows a side view of the substrate of the polar boundary marking system according to the third illustrated embodiment;

FIG. 6 show a top view of a measuring cord of the polar boundary marking system according to the third illustrated embodiment;

FIG. 7 shows a top view of the polar boundary marking system with measured boundary lines according to the third illustrated embodiment;

FIG. 8 shows a top view of the polar boundary marking system in accordance with a fourth illustrated embodiment;

FIG. 9 shows a bottom view of the polar boundary marking system according to the fourth illustrated embodiment;

FIG. 10 shows a top view of a simulated game court boundary of the polar boundary marking system according to the fourth illustrated embodiment; and

FIG. 11 shows a top view of a measuring cord of the polar boundary marking system according to the fourth illustrated embodiment.

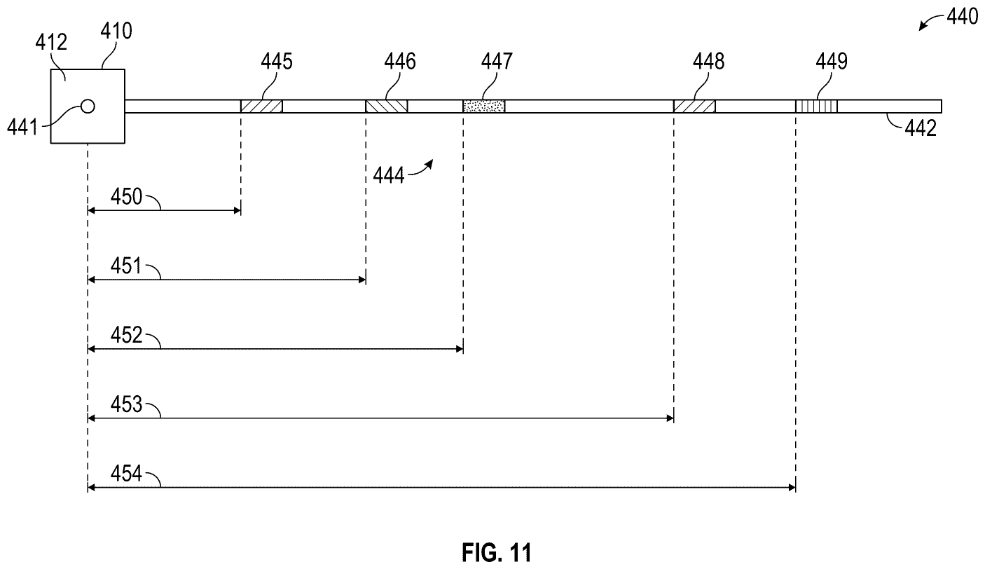

### DETAILED DESCRIPTION

For purposes of explanation and not limitation, details and descriptions of certain preferred embodiments are hereinafter provided such that one having ordinary skill in the art may be enabled to make and use the invention. These details and descriptions are representative only of certain preferred embodiments, however, a myriad of other embodiments which will not be expressly described will be readily understood by one having skill in the art upon a thorough review of the instant disclosure. Accordingly, any reviewer of the instant disclosure should interpret the scope of the invention only by the claims, as such scope is not intended to be limited by the embodiments described and illustrated herein.

For purposes herein, the term “associated” and “associated markings” means same or similar markings such that there is a perceived relationship between them. For example, letters that are upper case and lower case are associated. Colors that are the same color but different shade or tone are associated. Symbols having related meanings are associated. Additionally, markings that are identical in letter, shape, color or other differentiating feature are also associated with each other.

The term “differentiating feature” means a feature used to differentiate between different sets of markings. A differentiating feature can include different color, letters, numbers, shape, patterns, or any other feature that can be appreciated by one having skill in the art.

The term “simulated game boundary court” means a representation by the plurality of substrate markings that form a proportionally smaller version of the game boundary court that the respective polar boundary marking system is designed to recreate. The simulated game boundary court comprises corners, endpoints, and midpoints associated with corners, endpoints, and midpoints of the game boundary system that are proportional in distance to one another. In some embodiments, the simulated game boundary court may additionally comprise lines connecting the corners, endpoints, and midpoints of the simulated game boundary court.

The term “about” and “substantially” means having a tolerance of 5%.

The term “neutral colors” means colors that do not appear on a conventional color wheel and are not associated with any particular hue. Neutral colors may comprise grey, brown, beige, white, and black.

The term “vivid colors” means non-white colors that are intense, highly saturated, and do not include neutral colors. Vivid colors may comprise red, blue, green, pink, and yellow.

The term “origin” means a point on the substrate that may or may not be the center of the substrate.

The term “extending” means to begin at or be a distance from the specified location. Extending from a particular location means one end of the disclosed element is disposed on or space a distance from the specified location and the extension of the disclosed element is directed in a direction away from the specified location.

Unless explicitly defined herein, terms are to be construed in accordance with the plain and ordinary meaning as would be appreciated by one having skill in the art.

### General Description of Embodiments

In one general embodiment, a polar boundary marking system is disclosed. The polar boundary marking system comprises a substrate comprising a top surface, a bottom surface opposite the top surface, and center axle disposed at an origin of the top surface. The substrate further comprises a plurality of substrate markings extending radially from the origin, the plurality of substrate markings comprising a set of first substrate markings comprising a pair of collinear first markings extending in opposite directions from the origin, a set of second substrate markings comprising a pair of collinear second markings extending in opposite directions from the origin, a set of third substrate markings comprising two pairs of third markings extending radially from the origin, wherein each pair of the set of third substrate markings is collinear, and a set of fourth substrate markings comprising two pairs of fourth markings extending radially from the origin, wherein each pair of the set of fourth substrate markings is collinear. The first through fourth substrate markings each comprise a differentiating feature. A first quadrant, a second quadrant, a third quadrant, and a fourth quadrant are partitioned by the set of first substrate markings and the set of second substrate markings, wherein each of the first through fourth quadrants each comprise a first angle, a second angle, and a third angle. The first angle is formed by the first substrate marking and the fourth substrate marking, the second angle is formed by the first substrate marking and the third substrate marking, and the third angle is formed by the first substrate marking and the second substrate marking. The polar boundary marking system further comprises a measuring cord comprising a first terminal end and a second terminal end opposite the first terminal end. The first terminal end comprises a coupler element wherein the coupler element is configured to detachably and rotatably couple to the center axle. The measuring cord further comprises a plurality of cord markings, the plurality of cord markings comprising in order from the first terminal end a first cord marking, a second cord marking, a third cord marking, a fourth cord marking, and a fifth cord marking. Wherein the first and fourth cord markings are each associated with the first substrate marking, the second cord marking is associated with the second substrate marking, the third cord marking is associated with the third substrate marking, and the fifth cord marking is associated with the fourth substrate marking.

In some embodiments, the substrate may further comprise a first half and a second half wherein the first half and the second half are in a mirror configuration about the center axle.

In some embodiments, each of the first through fourth quadrants may be symmetrical about the origin.

In some embodiments, the first angle may comprise an angle of about 35.15 degrees, the second angle may comprise an angle of about 48.14 degrees, and the third angle may comprise an angle of about 90 degrees.

In some embodiments, the coupler element may comprise a ring.

In some embodiments the first through fifth cord markings may comprise a first through fifth length, respectively, from the terminal end, wherein the first length is about 7 feet, the second length is about 10 feet, the third length is about 12.21 feet, the fourth length is about 22 feet, and the fifth length is about 24.17 feet.

In another general embodiment, a polar boundary marking system is disclosed. The polar boundary marking system comprises a substrate and a measuring cord. The substrate comprises a top surface, a bottom surface opposite the top surface, and an origin disposed on the top surface, the origin comprising a center axle. The substrate further comprises a plurality of substrate markings extending radially from the origin. The measuring cord comprises a first terminal end and a second terminal end opposite the first terminal end wherein the measuring cord is configured to rotatably couple to the center axle at the first terminal end. The measuring cord further comprising a plurality of cord markings wherein each of the plurality of cord markings is associated with at least one of the plurality of substrate markings.

In some embodiments, the substrate further may comprise a first half and a second half wherein the first half and the second half are in a mirror configuration about the center axle.

In some embodiments, the plurality of substrate markings may further comprising a set of first substrate markings, a set of second substrate markings, a set of third substrate markings, and a set of fourth substrate markings. The first through fourth substrate markings may comprise a differentiating feature. The differentiating feature may comprise a color.

In some embodiments, the set of first substrate markings may comprise a pair of collinear first markings extending in opposite directions from the origin. The set of second substrate markings may comprise a pair of collinear second markings extending in opposite directions from the origin. The set of third substrate markings may comprise two pairs of third markings extending radially from the origin, wherein each pair of the set of third substrate markings is collinear. The set of fourth substrate markings may comprise two pairs of fourth markings extending radially from the origin, wherein each pair of the set of fourth substrate markings is collinear.

In some embodiments, the set of first substrate markings and the set of second substrate markings may partition the substrate into a first quadrant, a second quadrant, a third quadrant, and a fourth quadrant. Each of the first through fourth quadrants may symmetrical about the origin. Each of the first through fourth quadrants markings may comprise a first angle, a second angle, and a third angle formed by the plurality of substrate markings. The first angle may be formed by the first substrate marking and the fourth substrate marking, the second angle may formed by the first substrate marking and the third substrate marking, and the third angle may formed by the first substrate marking and the second substrate marking. The first angle may comprise an angle of about 35.15 degrees, the second angle may comprise an able of about 48.14 degrees, and the third angle may comprise an angle of about 90 degrees.

In some embodiments, the measuring cord may further a coupler element disposed at the first terminal end, the coupler element being configured to rotatably couple to the center axle. The coupler element may comprise a ring.

In some embodiments, the measuring cord may be configured to detachably couple to the center axle.

In some embodiments, the plurality of cord markings may further comprise in order from the first terminal end a first cord marking, a second cord marking, a third cord marking, a fourth cord marking, and a fifth cord marking. The first and fourth cord markings may each be associated with the first substrate marking, the second cord marking may be associated with the second substrate marking, the third cord marking may be associated with the third substrate marking, and the fifth cord marking may be associated with the fourth substrate marking.

In some embodiments, the first through fifth cord markings may comprise a first through fifth length, respectively, from the terminal end, wherein the first length is about 7 feet, the second length is about 10 feet, the third length is about 12.21 feet, the fourth length is about 22 feet, and the fifth length is about 24.17 feet.

In another general embodiment, a polar boundary marking system is disclosed. The boundary marking system comprises a substrate having a top surface, a bottom surface opposite the top surface, and an origin disposed on the top surface. The substrate further comprises a plurality of substrate markings having a set of first substrate markings, a set of second substrate markings, a set of third substrate markings, and a set of fourth substrate markings, wherein the first through fourth substrate markings each comprise a differentiating feature. The polar boundary marking system further comprises a measuring cord having a first terminal end and a second terminal end opposite the first terminal end, wherein the measuring cord is configured to rotatably couple to the origin. The measuring cord further comprises a plurality of cord markings, such that each of the plurality of cord markings is associated with at least one of the plurality of substrate markings.

In some embodiments, the plurality of cord markings may further comprise in order from the first terminal end a first cord marking, a second cord marking, a third cord marking, a fourth cord marking, and a fifth cord marking.

In some embodiments, the first and fourth cord markings may each be associated with the first substrate marking, the second cord marking may be associated with the second substrate marking, the third cord marking may be associated with the third substrate marking, and the fifth cord marking may be associated with the fourth substrate marking.

In some embodiments, the plurality of substrate markings may form a simulated game court boundary at the top surface. The simulated game court boundary comprises a plurality of game boundary corners disposed substantially equidistant from the origin to form a first major side, a second major side opposite the first major side, a first minor side, and a second minor side opposite the second minor side. The simulated game court boundary further comprises a longitudinal first half having an upper service area portion and an upper non-volley zone portion and a longitudinal second half having a lower service area portion and a lower non-volley zone portion.

In some embodiments, the set of second substrate markings may be substantially equidistant from the origin.

In some embodiments, wherein the set of third substrate markings are substantially equidistant from the origin.

In some embodiments, the set of fourth substrate markings may form the game boundary corners of the simulated game court boundary.

In some embodiments, the set of second substrate markings may form midpoints of the first major side and the second major side.

In some embodiments, a subset of the set of first substrate markings may form midpoints of the first minor side and the second minor side.

In some embodiments, the set of first substrate markings may comprise a collinear alignment, wherein the origin bisects the set of first substrate markings.

In some embodiments, the upper service area portion and the lower service area portion may each be formed by subsets of the set of first substrate markings, the set of third substrate markings, and the set of fourth substrate markings.

In some embodiments, the upper non-volley zone portion and the lower non-volley zone portion may be formed by subsets of the set of first substrate markings, the set of second substrate markings, and the set of third substrate markings.

In some embodiments the first through fifth cord markings may comprise a first through fifth length, respectively, from the terminal end, wherein the first length is about 7 feet, the second length is about 10 feet, the third length is about 12.21 feet, the fourth length is about 22 feet, and the fifth length is about 24.17 feet.

In a general embodiment, a court boundary stencil is disclosed. The court boundary stencil comprises a stencil periphery having a first major side, a second major side opposite the first major side, a first minor side, and a second minor side opposite the first minor side. The stencil periphery further comprises a first corner formed by an intersection of the first major side and the first minor side, a second corner formed by an intersection of the second major side and the first minor side, a third corner formed by an intersection of the second major side and the second minor side, and a fourth corner formed by an intersection of the first major side and the second minor side. The stencil periphery comprises a longitudinal upper half and a longitudinal lower half. A first diagonal strap extends from a first terminal end to a second terminal end, wherein the first diagonal strap is coupled to the second corner and the fourth corner. A second diagonal strap extends from a third terminal end to a fourth terminal end, wherein the second diagonal strap is coupled to the first corner and the third corner, wherein the strap diagonal strap is additionally coupled to the strap diagonal strap at a stencil center. The court boundary stencil further comprises a plurality of indicators disposed on the stencil periphery comprising a first upper non-volley indicator disposed on the first major side at the longitudinal upper half, a second upper non-volley indicator disposed on the second major side at the longitudinal upper half, wherein the second upper non-volley indicator and the first upper non-volley indicator are equally distanced from the first minor side, a first center indicator disposed at a midpoint of the first minor side, a first lower non-volley indicator disposed on the first major side at the longitudinal lower half, a second lower non-volley indicator disposed on the second major side at the longitudinal lower half, wherein the second lower non-volley indicator and the first lower non-volley indicator are equally distanced from the second minor side, and a second center indicator disposed at a midpoint of the second minor side.

In some embodiments, the first terminal end and the second terminal end may each extend beyond the second corner and the fourth corner, respectively, such that the second corner and the fourth corner are each disposed between the first terminal end and the second terminal end. The third terminal end and the fourth terminal end may each extend beyond the first corner and the third corner, respectively, such that the first corner and the third corner are each disposed between the third terminal end and the fourth terminal end.

In some embodiments, the first through fourth terminal ends may each comprise a grommet. In some embodiments, the stencil center further comprises a grommet coupler configured to couple to each of the grommets. The grommet coupler may further comprise a carabiner clip.

In another general embodiment, a court boundary stencil is disclosed. The court boundary stencil comprises a stencil periphery having a first major side, a second major side opposite the first major side, a first minor side, and a second minor side opposite the first minor side, the stencil periphery further comprising a longitudinal upper half and a longitudinal lower half partitioned by a stencil center. A first non-volley boundary strap is coupled to each of the first major side and the second major side at the longitudinal upper half. A first center boundary strap is coupled to both a midpoint of the first minor side and a midpoint of the first non-volley boundary strap. A second non-volley boundary strap is coupled to each of the first major side and the second major side at the longitudinal lower half. A second center boundary strap is coupled to both a midpoint of the second minor side and a midpoint of the second non-volley boundary strap. A central strap coupled to each of the midpoint of the first non-volley boundary strap and the midpoint of the second non-volley boundary strap.

In some embodiments, the central support strap may be colinear with the first center boundary strap and the second boundary strap.

In some embodiments, the central support strap may be parallel with the first major side and the second major side.

In some embodiments, the stencil periphery, the first non-volley boundary strap, the second non-volley boundary strap, the first center boundary strap, and the second center boundary strap may each comprise a uniform vivid color. The central support strap may comprise a neutral color.

In some embodiments, the court boundary stencil may further comprise a plurality of anchor strap coupled to and extending away from the stencil periphery. Each of the plurality of anchor straps may comprise at least one grommet. The stencil center may further comprise a grommet coupler disposed on the central support straps, the grommet coupler configured to couple with each of the grommets.

While various details, features, combinations are described in the illustrated embodiments, one having skill in the art will appreciate a myriad of possible alternative combinations and arrangements of the features disclosed herein. As such, the descriptions are intended to be enabling only, and non-limiting. Instead, the spirit and scope of the invention is set forth in the appended claims. Alternative embodiments may comprise combinations of elements and features disclosed embodiments. For example, and without limitation, a polar boundary marking system may comprise a substrate having plurality of markings being both a simulated game boundary and radially extend lines.

### First Illustrated Embodiment

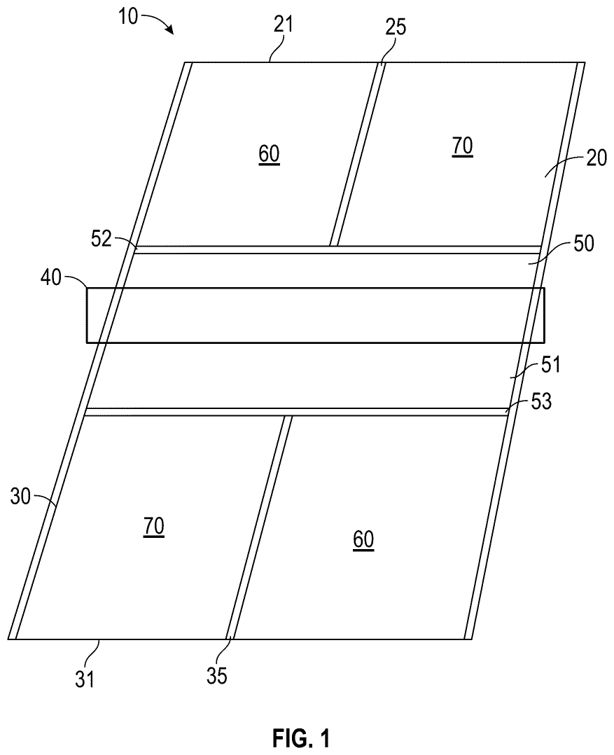

Now turning to the drawings, FIG. 1 shows game court boundary lines (10) to a game of pickleball. The game court boundary lines comprise an upper half (20), and a lower half (30) in mirror configuration about a net (40). The upper half and lower half comprise an upper non-volley zone (50) and a lower non-volley (51), respectively, disposed on either side of the net. The upper half comprises an upper center boundary line (25) extending from an upper edge (21) to the upper non-volley zone to dissect the upper half. Similarly, the lower half comprises a lower center boundary line (35) extending from a lower edge (31) to the lower non-volley zone to bisect the lower half. The upper half and the lower half each comprise a right service area (60) and a left service area (70). An upper non-volley boundary line (52) extends parallel to the net and separates the right service area and the left service area from the upper non-volley zone. Similarly, a lower non-volley boundary line (53) extends parallel to the net and separates the right service area and the left service area from the lower non-volley zone.

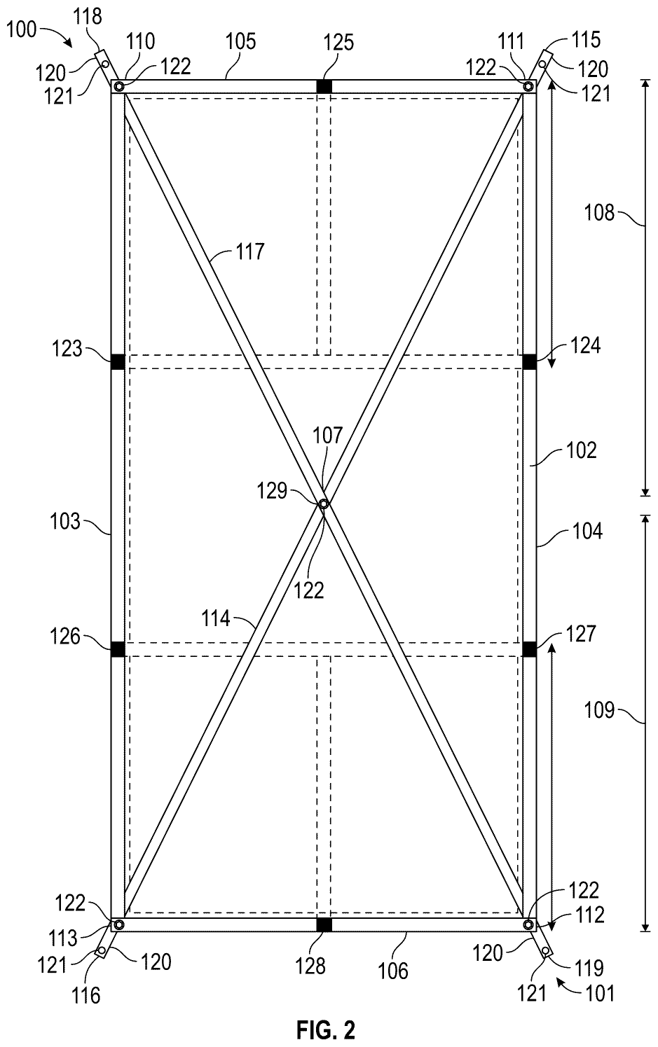

FIG. 2 shows a court boundary stencil (100) in accordance with a first illustrate embodiment utilized for drawing boundary lines for a related game. The court boundary stencil comprises a plurality of straps (101) forming the court boundary stencil including a stencil periphery (102). The stencil periphery comprises a first major side (103), a second major side (104) opposite the first major side, a first minor side (105), and a second minor side (106) opposite the first minor side. An intersection of the first major side and the first minor side forms a first corner (110), an intersection of the second major side and the first minor side forms a second corner (111), an intersection of the second major side and the second minor side forms a third corner (112), and an intersection of the first major side and the second minor side forms a fourth corner (113). The court boundary stencil can be divided into a longitudinal upper half (108) and a longitudinal lower half (109) about a stencil center (107).

The court boundary stencil (100) further comprises a first diagonal strap (114) extending from a first terminal end (115) to a second terminal end (116), wherein the first diagonal strap couples to the second corner (111) and the fourth corner (113). The first terminal end and the second terminal end each form an anchor strap (120) by extending beyond the second corner and the fourth corner, respectively, such that the second corner and the fourth corner are each disposed between the first terminal end and the second terminal end. The first and second terminal ends each comprise a grommet (121).

The court boundary stencil (100) further comprises a second diagonal strap (117) extending from a third terminal end (118) to a fourth terminal end (119), wherein the second diagonal strap couples to the first corner (110) and the third corner (112). The third terminal end and the fourth terminal end each form an anchor strap (120) by extending beyond the first corner and the third corner, respectively, such that the first corner and the third corner are each disposed between the third terminal end and the fourth terminal end. The third and fourth terminal ends each comprise a grommet (121). The second diagonal strap further couples to the first diagonal strap at the stencil center. The first and second diagonal straps provide support to the stencil periphery (102) to ensure proper alignment and linearity.

The stencil periphery (102) comprises a plurality of indicators at the longitudinal upper half (108) and the longitudinal lower half (109) which are used to aid players in correctly marking necessary boundary lines of the associated game. The plurality of indicators at the longitudinal upper half comprises a first upper non-volley indicator (123), a second upper non-volley indicator (124), and a first center indicator (125). The first upper non-volley indicator is disposed on the first major side (103) and the second upper non-volley indicator is disposed on the second major side (104). The first and second upper non-volley indicators are spaced equally from the first minor side (105) such that a line formed by the first and second upper non-volley indicators is parallel to the first minor side and orthogonal to each of the first major side and the second a major side. The first center indicator is disposed on the first minor side and bisects the first minor side equally in half. The first and second upper non-volley indicators aid the player in marking an upper non-volley boundary line of an upper non-volley zone. The first center indicator aids in marking a boundary line that separates a right service area from a left service area in the longitudinal upper half. Each of the indicators may comprise a thickness of about 2 inches to match a desirable 2-inch boundary line common in the game of pickleball.

Similarly, the plurality of indicators at the longitudinal lower half (109) comprises a first lower non-volley indicator (126), a second lower non-volley indicator (127), and a second center indicator (128). The first lower non-volley indicator is disposed on the first major side (103) and the second lower non-volley indicator is disposed on the second major side (104). The first and second lower non-volley indicators are spaced equally from the second minor side (106) such that a line formed by the first and second lower non-volley indicators is parallel to the second minor side and orthogonal to each of the first major side and the second a major side. The second center indicator is disposed on the second minor side and bisects the second minor side equally in half. The first and second lower non-volley indicators aid players in marking a lower non-volley boundary line of a lower non-volley zone. The second center indicator aids in marking a boundary line that separates a right service area from a left service area. Each of the indicators may comprise a thickness of about 2 inches to match a desirable 2-inch boundary line common in the game of pickleball.

In one aspect, a method of using the court boundary stencil (100) comprises laying the court boundary stencil flat on a ground surface, taping the anchor straps (120) to the ground surface, applying chalk, tape, or some other temporary marking device to mark the four corners and the six indicators, removing the court boundary stencil, and connecting the four corners and the six indicators accordingly with the temporary marking device. The four corners are connected by the temporary marking device to form the stencil periphery (102). The first upper non-volley indicator (123) is connected with the second upper non-volley indicator (124) to form an upper non-volley boundary line. The first center indicator (125) is then connected at a midpoint of upper non-volley boundary line. Similarly, the first lower non-volley indicator (126) is connected with the second lower non-volley indicator (127) to from a lower non-volley boundary line (128). The second center indicator is then connected at a midpoint of the lower non-volley boundary line.

To ensure the upper and lower non-volley boundary lines are straight, prior to removing the court boundary stencil (100), the stencil can be folded such that the first corner (110) overlays with the first upper non-volley indicator (123), the second corner (111) overlays with the second upper non-volley indicator (124), the third corner (112) overlays with the second lower non-volley indicator (127), and the fourth corner (113) overlays with the first lower non-volley indicator (126). In such a configuration, the first minor side (105) can be used to aid in marking the upper non-volley boundary line and the second minor side (106) can be used to aid in marking the lower non-volley boundary line.

The stencil center (107) further comprises a grommet coupler (129) disposed at the intersection of the first diagonal strap (114) and the second diagonal strap (117). The grommet coupler is configured to engage with each grommet (121) from the anchor straps (120). When players are finished with the court boundary stencil (100), each of the grommets can be folded and coupled to the grommet coupler to mitigate chances that the plurality of straps will tangle during storage and transportation. In other embodiments, the center comprises a grommet instead of a grommet coupler so an external rope can be used to tie the corner grommets with the center grommet. The grommet coupler may include a carabiner clip. Other grommet couplers may also be utilized for engaging with the grommets.

The plurality of straps (101) is fixedly coupled together and may comprise a flattened structure that is both flexible for storing and inelastic to preserve accuracy of game boundary dimensions. There are myriad of configurations to form the court boundary stencil. As shown, the court boundary stencil illustrates a configuration that uses minimal individual sections of straps and minimal stich couplings. Each of the first major side (103), the second major side (104), the first minor side (105), the second minor side (106), the first diagonal strap (114), and the second diagonal strap (115) comprises a single individual section. A stitch coupling (122) is located at the intersections of each corner and diagonal straps, as well as the intersection of the first diagonal strap and the second diagonal strap for a total of five stitch couplings.

The court boundary stencil (100) is optimized for marking boundary lines for a game of pickleball. The first and second major sides (103; 104) are each about 44 feet, and the first and second minor sides (105; 106) are each about 20 feet. Distance from the first and second upper non-volley indicators (123; 124) is about 15 feet from the first minor side. Likewise, distance from the first and second lower non-volley indicators (126; 127) is about 15 feet from the second minor side. Each of the plurality of straps (101) may comprise a thickness of about one inch.

### Second Illustrated Embodiment

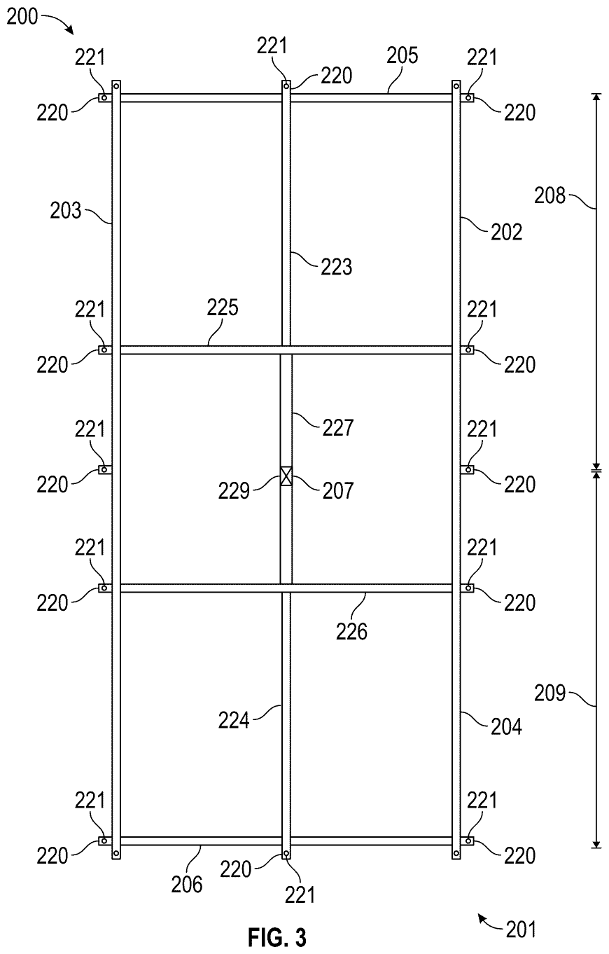

FIG. 3 shows a court boundary stencil (200) in accordance with a second illustrated embodiment utilized for drawing boundary lines of a related game. The court boundary stencil comprises a plurality of straps (201) forming the court boundary stencil including a stencil periphery (202). The stencil periphery comprises a first major side (203), a second major side (204) opposite the first major side, a first minor side (205), and a second minor side (206) opposite the first minor side. The court boundary stencil can be divided into a longitudinal upper half (208) and a longitudinal lower half (209) about a stencil center (207). The plurality of straps is fixedly coupled together and may comprise a flattened structure that is both flexible for storing and inelastic to preserve accuracy of game boundary dimensions.

The longitudinal upper half (208) comprises a first center boundary strap (223) and a first non-volley boundary strap (225). The first center boundary strap extends from a midpoint of the first minor side (205) towards the stencil center (207). The first non-volley boundary strap extends linearly across the longitudinal upper half from the first major side (203) to the second major side (204). The first non-volley boundary strap is coupled to an endpoint of the first center boundary strap.

Likewise, the longitudinal lower half (209) comprises a second center boundary strap (224) and a second non-volley boundary strap (226). The second center boundary strap extends from a midpoint of the second minor side (206) towards the stencil center (207). The second non-volley boundary strap extends linearly across the longitudinal lower half from the first major side (203) to the second major side (204). The second non-volley boundary strap is coupled to an endpoint of the second center boundary strap.

The plurality of straps (201) further comprise a central support strap (227) coupled to each of the midpoint of the first non-volley boundary strap (225) and the midpoint of the second non-volley boundary strap (226) to linearly extend the first center boundary strap (223) with the second center boundary strap (224). The central support strap provides support to the court boundary stencil (202) to ensure each of the plurality of straps is properly aligned and straight. The central support strap may comprise a different color from the other straps to designate a non-boundary strap. In some embodiments, the court boundary stencil (200) itself can be used as the boundary lines of the game such that the players play on top of the court boundary stencil. In such embodiments, the stencil periphery, the center boundary straps, and the non-volley boundary straps may each comprise a uniform vivid color for easy recognition. The central support strap may comprise a neutral color in order to blend with the ground surface and differentiate from the other straps used to indicate boundary lines of the game.

The court boundary stencil (200) further comprises anchor straps (220) coupled to and extending away from the stencil periphery (202). As illustrated, the anchor straps are disposed at corners of the stencil periphery, endpoints of the non-volley boundary straps (224; 226), midpoints of the first and second major sides (203; 204), and midpoints of the first and second minor sides (205; 206). The anchor straps can be taped or otherwise adhered to a ground surface in order to keep the court boundary stencil in place while the stencil is used for marking the ground surface or is used as the game boundary lines. The anchor straps allow the court boundary stencil to be held in place without visually interfering with the stencil periphery. One or more of the anchor straps may comprise a grommet (221).

The stencil center (207) further comprises a grommet coupler (229) disposed on the central support strap (227). The grommet coupler is configured to engage with each grommet (221) from the anchor straps (220). When players are finished with the court boundary stencil (200), each of the grommets can be folded and coupled to the grommet coupler to mitigate chances of the plurality of straps (201) tangling during storage and transportation. In other embodiments, the center comprises a grommet instead of a grommet coupler so an external rope can be used to tie the corner grommets with the center grommet. The grommet coupler may include a carabiner clip. Other grommet couplers may also be utilized for engaging with the grommets.

The court boundary stencil (200) as shown is optimized for marking boundary lines for a game of pickleball. The first and second major sides (203; 204) are each about 44 feet, and the first minor side (205), the second minor side (206), the first non-volley boundary strap (225), and the second non-volley boundary strap (226) are each about 20 feet. The first and second center boundary straps (223; 224) are each about 15 feet. Lastly, the central support strap (227) is about 14 feet. Each of the plurality of straps (201) may comprise a thickness of about two inches.

### Third Illustrated Embodiment

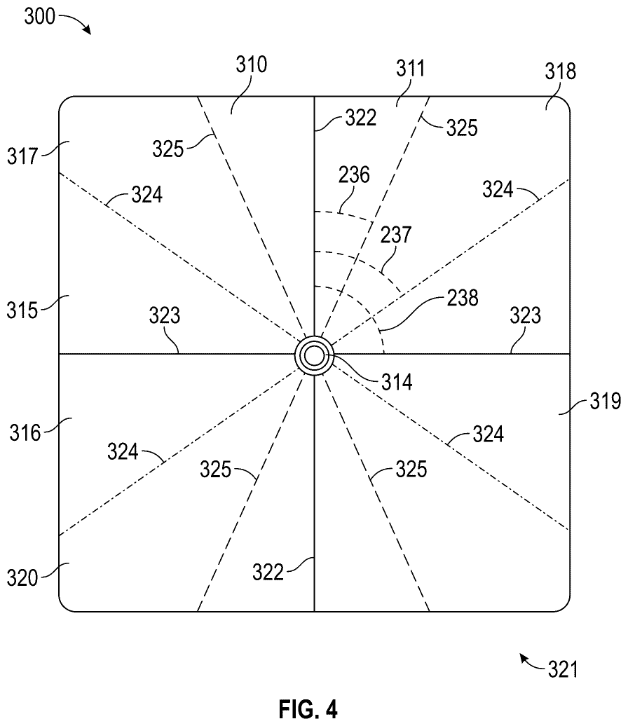

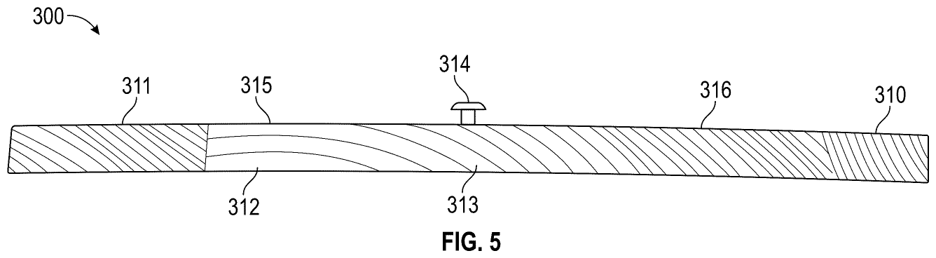

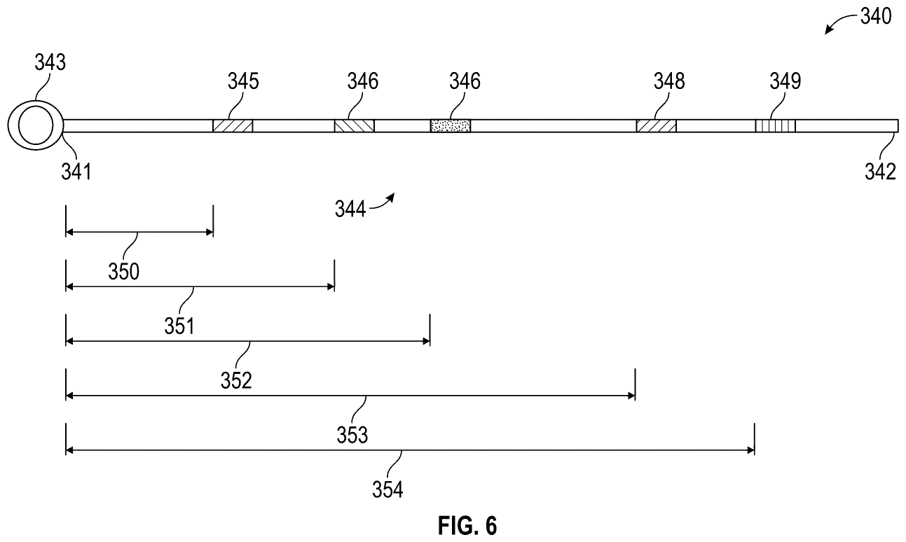

FIGS. 3-7 show a polar boundary marking system (300) in accordance with a third illustrated embodiment. The polar boundary marking system comprises a substrate (310) and a measuring cord (340) rotatably coupled to the substrate. The substrate comprises a plurality of substate markings (321) and the measuring cord comprises a plurality of cord markings (344) such that each of the plurality of cord markings is associated with at least one of the plurality of substrate markings. When the measuring cord is rotatably coupled to an origin (313) of the substrate, the measuring cord can be linearly aligned with any of the plurality of substrate markings to establish an accurate angle. Accurate distance is established by at least one of the plurality of cord markings being associated with a marking on the substrate in which the measuring cord is linearly aligned with. After polar coordinates comprising the angle and distance are determined, a particular boundary line, such as a corner, endpoint, or edge, can be marked using the calculated polar coordinates. The polar boundary marking system disclosed herein has particular dimensions optimized for the game of pickleball. One having skill in the art will appreciate that the polar boundary marking system can be used with other games using alternative dimensions to measure boundaries directed to those other games.

The substrate (310) comprises a top surface (311) and a bottom surface (312) opposite the top surface. Extending from the top surface at the origin of the substrate is a center axle (314). The top and bottom surfaces comprise a substantial flat surface. The substrate comprises a first half (315) and a second half (316) wherein first and second halves are in a mirror configuration about the center axle. The plurality of substrate markings (321) comprises a set of first substrate markings (322), a set of second substrate markings (323), a set of third substrate markings (324), and a set of fourth substrate markings (325). As shown, the plurality of substrate markings comprises distinct colors to aid in differentiation. Other kinds of markings can be used including letter, symbols, hash marks, or any other kinds of markings that can be appreciated by one having skill in the art. The set of first substrate markings comprises two collinear black markings extending in opposite directions from the center axle. The set of second substrate markings comprise two collinear blue markings extending in opposite directions from the center axle. The set of third substrate markings comprise four red markings extending radially from the center axle such that two of the four red markings are collinear with each other, and another two of the four red markings are collinear with each other. Lastly, the set of fourth substrate markings comprise four green markings extending radially from the center axle such that two of the four green markings are collinear with each other, and another two of the four green markings are colinear with each other. In other embodiments alternative color combinations can be utilized.

The set of first substrate markings (322) and the set of second substrate markings (323) partition the substrate (310) into a first quadrant (317), a second quadrant (318), a third quadrant (319), and a fourth quadrant (320) wherein each of the first through fourth quadrants are equal in size and symmetrical about the origin (313). Each of the first through fourth quadrants comprises the first through fourth substrate markings. Within each of the first through fourth quadrants is a plurality of angles formed by the plurality of substrate markings, namely a first angle (326), a second angle (327), and a third angle. (328) The first angle is formed by the first substrate marking and the fourth substrate marking (320). The second angle is formed by the first substrate marking and the third substrate marking (324). The third angle is formed by the first substrate marking and the second substrate marking. In an embodiment directed to the game of pickleball, the first angle is about 35.15 degrees, the second angle is about 48.14 degrees, and the third angle is about 90 degrees.

The measuring cord (340) comprises a first terminal end (341) and a second terminal end (342) opposite the first terminal end. A coupler element (343) is disposed at the first terminal end and is configured to rotatably couple to the center axle (314). As shown, the coupler element comprises a ring. Rotatable coupling of the coupler element to the center axle can be detachable or fixed. The plurality of cord markings (344) disposed on the measuring cord comprise, in order from the first terminal end, a first cord marking (345), a second cord marking (346), a third cord marking (347), a fourth cord marking (348), and a fifth cord marking (349). The first and fourth cord markings are each associated with the first substrate marking (322). The second cord marking is associated with the second substrate marking (323). The third cord marking is associated with the third substrate marking (324). And the fifth cord marking is associated with the fourth substrate marking (325). Each of the first through fifth cord markings may comprise a thickness which is equivalent to a standard boundary thickness for a particular game the polar boundary marking system is designed for. For example, each of the markings may comprise a thickness of 2 inches with a 10% tolerance to comply with pickleball regulations.

In one embodiment, each of the first through fifth cord markings (345; 346; 347; 348; 349) may comprise a first through fifth length (350; 351; 352; 353; 354), respectively, from the first terminal end (341) to accurately measure boundary lines for pickleball. In such an embodiment, the first length is about 7 feet, the second length is about 10 feet, the third length is about 12.21 feet, the fourth length is about 22 feet, and the fifth length is about 24.17 feet. The first cord marking is configured to designate a center of a non-volley zone (361) of a game boundary (360), the second cord marking is configured to designate midpoint of a major side (362) of the game boundary, the third cord marking is configured to designate an endpoint of the non-volley zone of the game boundary, the fourth cord marking is configured to designate a midpoint of a minor side (363) of the game boundary, and the fifth cord marking is configured to designate a corner (364) of the game boundary.

In one aspect, a method of marking boundaries to a game comprises (i) attaching the measuring cord to the center axle of the substrate; (ii) placing the substrate at the center of the desired game boundary; (iii) extending the measuring cord until it is taught; (iv); aligning the measuring cord with one of the plurality of substrate markings; (v) matching one or more cord markings associated with one of the plurality of substrate markings aligned with the measuring cord; (vi) marking the ground surface corresponding to the one or more cord markings associated with the substrate marking aligned with the measuring cord; (vii) repeating steps (iv)-(vi) until all substrate markings have been aligned with and corresponded to one or more cord markings; and (viii) connecting each of the markings on the ground surface for creating boundaries of the game. Connecting the markings can may involve use of chalk, tape, or other means.

### Fourth Illustrated Embodiment

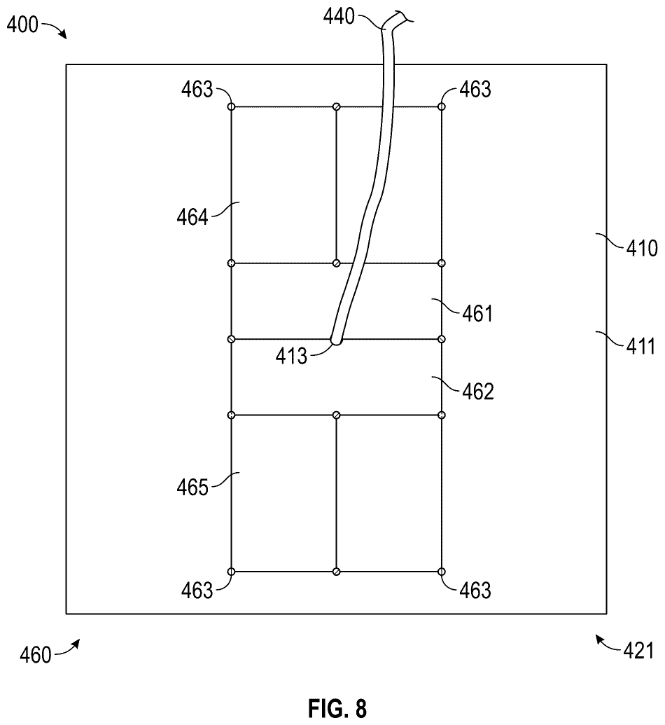

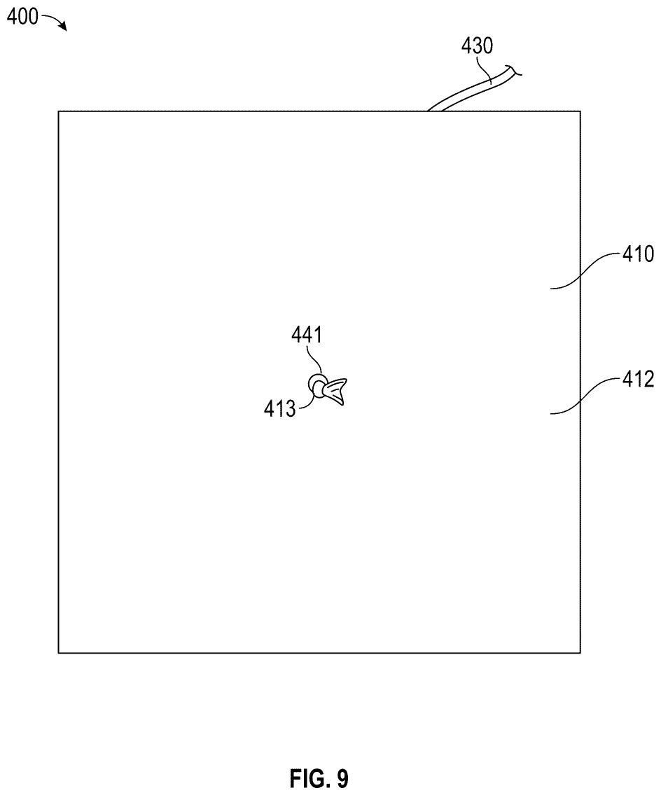

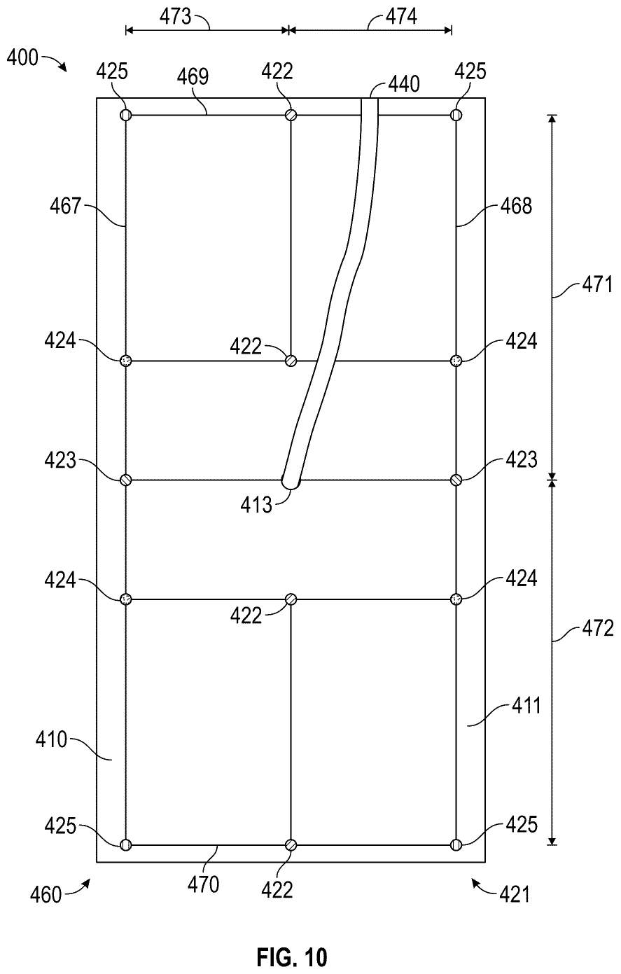

FIGS. 8-10 show a polar boundary marking system (400) in accordance with a fourth illustrated embodiment. The polar boundary marking system comprises a substrate (410) and a measuring cord (440) rotatably coupled to the substrate at an origin (413) thereof. The substrate comprises a plurality of substate markings (421) and the measuring cord comprises a plurality of cord markings (444) such that each of the plurality of cord markings is associated with at least one of the plurality of substrate markings. When the measuring cord is rotatably coupled to an origin (413) of the substrate, the measuring cord can intersect with any of the plurality of substrate markings to establish an accurate angle. Accurate distance is established by at least one of the plurality of cord markings being associated with a marking on the substrate that is intersected by the measuring cord. After polar coordinates comprising the angle and distance are determined, a particular boundary line, such as a corner, endpoint, or edge, can be marked using the calculated polar coordinates. The polar boundary marking system disclosed herein has particular dimensions optimized for the game of pickleball. One having skill in the art will appreciate that the polar boundary marking system can be used with other games using alternative dimensions to measure boundaries directed to those other games.

The substrate (410) comprises a top surface (411) and a bottom surface (412) opposite the top surface. The top and bottom surfaces comprise a substantial flat surface. The plurality of substrate markings (421) comprises a set of first substrate markings (422), a set of second substrate markings (423), a set of third substrate markings (424), and a set of fourth substrate markings (325). As illustrated, the plurality of substrate markings comprises points such as circles or squares. In other embodiments, the plurality of substrate markings may comprise lines extending radially form the origin. The plurality of substrate markings is shown with particular patterns to represent distinct colors as differentiating feature between each set of substrate markings to aid in differentiation. Other kinds of markings can be used including letter, symbols, hash marks, or any other kinds of markings that can be appreciated by one having skill in the art. As shown, plurality of substrate markings is connected together by lines to better represent the associated game court boundary. In other embodiments the plurality of substrate markings comprises disconnected points.

The plurality of substrate markings (421) forms a simulated game court boundary (460) on the top surface (411) of the substrate (410). The simulated game court boundary comprises a plurality of game boundary corners (463) disposed substantially equidistant from the origin (413) to form a first major side (467), a second major side (468) opposite the first major side, a first minor side (469), and a second minor side (470) opposite the first minor side. The simulated game court boundary further comprises a longitudinal first half (471) having an upper service area portion (464) and an upper non-volley zone portion (461), and a longitudinal second half (472) having a lower service area portion (465) and a lower non-volley zone portion (462). The simulated game court boundary additionally includes a lateral first half (473) and a lateral second half (474).

The set of first substrate markings (422) comprise four red points in collinear alignment with one another and is bisected by the origin (413). The set of second substrate markings (423) comprise two green points disposed substantially equidistant from the origin. The set of second substrate markings form midpoints of the first major side (467) and the second major side (468). The set of third substrate markings (424) comprise four orange points disposed substantially equidistant from the origin. The set of fourth substrate markings (425) comprise four blue points. The set of fourth substrate markings form the game boundary corners (463).

Midpoints of the first minor side (469) and second minor side (470) are formed by a subset of the set of first substrate markings (422). The upper service area portion (464) and the lower service area portion (465) are each formed by subsets of the set of first substrate markings (422), the set of third substrate markings (424), and the set of the fourth substrate markings (425). The upper non-volley zone portion (461) and the lower non-volley zone portion (462) are formed by subsets of the set of first substrate markings (422), the set of second substrate markings (423), and the set of third substrate markings (424).

The measuring cord (440) comprises a first terminal end (441) and a second terminal end (442) opposite the first terminal end. The first terminal end is coupled to origin (413) at the bottom surface (412) of the substrate (410). The measuring cord extends through the substrate from the bottom surface to the top surface (411) and is configured to rotate about the origin. The plurality of cord markings (444) disposed on the measuring cord comprise, in order from the first terminal end, a first cord marking (445), a second cord marking (446), a third cord marking (447), a fourth cord marking (448), and a fifth cord marking (449). The first and fourth cord markings are each associated with the first substrate marking (422). The second cord marking is associated with the second substrate marking (423). The third cord marking is associated with the third substrate marking (424). And the fifth cord marking is associated with the fourth substrate marking (425). Each of the first through fifth cord markings may comprise a thickness which is equivalent to a standard boundary thickness for a particular game the polar boundary marking system is designed for. For example, each of the markings may comprise a thickness of 2 inches with a 10% tolerance to comply with pickleball regulations.

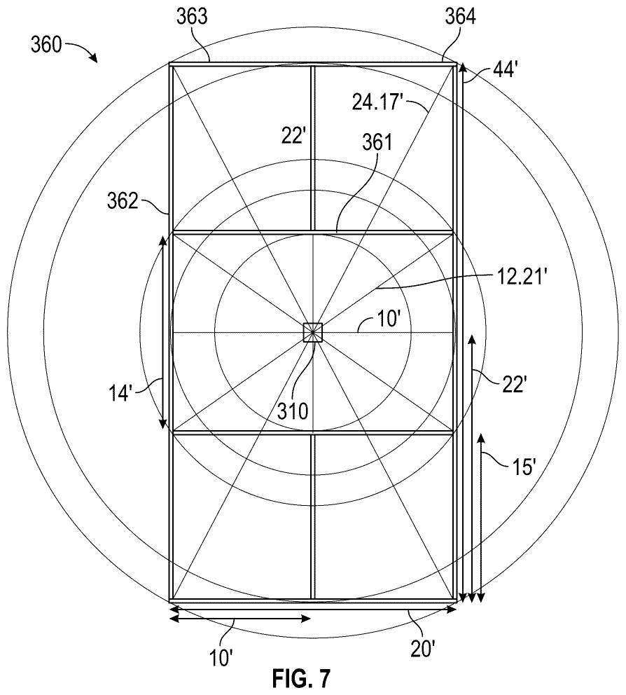

In one embodiment, each of the first through fifth cord markings (445; 446; 447; 448; 449) may comprise a first through fifth length (450; 451; 452; 453; 454), respectively, from the origin (413) to accurately measure boundary lines for pickleball. In such an embodiment, the first length is about 7 feet, the second length is about 10 feet, the third length is about 12.21 feet, the fourth length is about 22 feet, and the fifth length is about 24.17 feet. The first cord marking is configured to designate a center of a non-volley zone (FIG. 7; 361) of a game boundary (FIG. 7 360), the second cord marking is configured to designate midpoint of a major side (FIG. 7; 362) of the game boundary, the third cord marking is configured to designate an endpoint of the non-volley zone of the game boundary, the fourth cord marking is configured to designate a midpoint of a minor side (FIG. 7; 363) of the game boundary, and the fifth cord marking is configured to designate a corner (FIG. 7; 364) of the game boundary.

In one aspect, a method of marking boundaries to a game comprises (i) placing the substrate at a center of the desired game boundary; (ii) extending the measuring cord until it is taught; (iii); intersecting the measuring cord with one of the plurality of substrate markings; (iv) matching one or more cord markings associated with one of the plurality of substrate markings intersected with the measuring cord; (v) marking the ground surface corresponding to the one or more cord markings associated with the substrate marking intersected with the measuring cord; (vi) repeating steps (iii)-(v) until all substrate markings have been intersected with and corresponded to one or more cord markings; and (vii) connecting each of the markings on the ground surface for creating boundaries of the game. Connecting the markings can may involve use of chalk, tape, or other means.

Generally, the court boundary stencil may comprise materials such as nylon, polyester, polypropylene, rubber, synthetic rubber, or any other soft, durable and inelastic material. The straps may comprise a slip resistant coating applied on either or both surfaces to increase friction against shoe soles or hard surfaces.

Each of the components of the court boundary stencil and the polar boundary marking system described herein may be manufactured and/or assembled in accordance with the conventional knowledge and level of a person having skill in the art.

While various details, features, and combinations are described in the illustrated embodiments, one having skill in the art will appreciate a myriad of possible alternative combinations and arrangements of the features disclosed herein. As such, the descriptions are intended to be enabling only, and non-limiting. Instead, the spirit and scope of the invention is set forth in the appended claims.

### FEATURE LIST

game court boundary lines (10)
upper half (20)
upper edge (21)
upper center boundary line (25)
lower half (30)
lower edge (31)
lower center boundary line (35)
net (40)
upper non-volley zone (50)
lower non-volley zone (51)
upper non-volley boundary line (52)
lower non-volley boundary line (53)
right service area (60)
left service area (70)
court boundary stencil (100; 200)
plurality of straps (101; 201)
stencil periphery (102; 202)
first major side (103; 203)
second major side (104; 204)
first minor side (105; 205)
second minor side (106; 206)
stencil center (107; 207)
longitudinal upper half (108; 208)
longitudinal lower half (109; 209)
first corner (110)
second corner (111)
third corner (112)
fourth corner (113)
first diagonal strap (114)
first terminal end (115)
second terminal end (116)
second diagonal strap (117)
third terminal end (118)
fourth terminal end (119)
anchor strap (120; 220)
grommet (121; 221)
stitch coupling (122)
first upper non-volley indicator (123)
second upper non-volley indicator (124)
first center indicator (125)
first lower non-volley indicator (126)
second lower non-volley indicator (127)
second center indicator (128)
grommet coupler (129; 229)
first center boundary strap (223)
second center boundary strap (224)
first non-volley boundary strap (225)
second non-volley boundary strap (226)
central support strap (227)
polar boundary marking system (300; 400)
substrate (310; 410)
top surface (311; 411)
bottom surface (312; 412)
origin (313; 413)
center axle (314)
first half (315)
second half (316)
first quadrant (317)
second quadrant (318)
third quadrant (319)
fourth quadrant (320)
plurality of substrate markings (321; 421)
set of first substrate markings (322; 422)
set of second substrate markings (323; 423)
set of third substate markings (324; 424)
set of fourth substate markings (325; 425)
first angle (326)
second angle (327)
third angle (328)
measuring cord (340; 440)
first terminal end (341; 441)
second terminal end (342; 442)
coupler element (343)
plurality of cord markings (344; 444)
first cord marking (345; 445)
second cord marking (346; 446)
third cord marking (347; 447)
fourth cord marking (348; 448)
fifth cord marking (349; 449)
first length (350; 450)
second length (351; 451)
third length (352; 452)
fourth length (353; 453)
fifth length (354; 454)
game boundary (360)
non-volley zone (361)
major side (362)
minor side (363)
corner (364)
simulated game court boundary (460)
upper non-volley zone portion (461)
lower non-volley zone portion (462)
game boundary corner (463)
upper service area portion (464)
lower service area portion (465)
first major side (467)
second major side (468)
first minor side (469)
second minor side (470)
longitudinal first half (471)
longitudinal second half (472)
lateral first half (473)
lateral second half (474)

What is claimed is:

1. A polar boundary marking system, comprising:
a substrate comprising a top surface, a bottom surface opposite the top surface, and an origin disposed on the top surface, the substrate further comprising a plurality of substrate markings having a set of first substrate markings, a set of second substrate markings, a set of third substrate markings, and a set of fourth substrate markings, wherein the first through fourth substrate markings each comprise a differentiating feature; and
a measuring cord comprising a first terminal end and a second terminal end opposite the first terminal end, wherein the measuring cord is configured to rotatably couple to the origin, the measuring cord further comprising a plurality of cord markings;
wherein each of the plurality of cord markings is associated with at least one of the plurality of substrate markings.

2. The polar boundary marking system of claim 1, the plurality of cord markings further comprising in order from the first terminal end a first cord marking, a second cord marking, a third cord marking, a fourth cord marking, and a fifth cord marking.

3. The polar boundary marking system of claim 2, wherein the first and fourth cord markings are each associated with the first substrate marking, the second cord marking is associated with the second substrate marking, the third cord marking is associated with the third substrate marking, and the fifth cord marking is associated with the fourth substrate marking.

4. The polar boundary marking system of claim 1, wherein the plurality of substrate markings forms a simulated game court boundary at the top surface, the simulated game court boundary comprising:
a plurality of game boundary corners disposed substantially equidistant from the origin to form a first major side, a second major side opposite the first major side, a first minor side, and a second minor side opposite the second minor side;
a longitudinal first half having an upper service area portion and an upper non-volley zone portion; and
a longitudinal second half having a lower service area portion and a lower non-volley zone portion.

5. The polar boundary marking system of claim 4, wherein the set of second substrate markings are substantially equidistant from the origin.

6. The polar boundary marking system of claim 4, wherein the set of third substrate markings are substantially equidistant from the origin.

7. The polar boundary marking system of claim 4, wherein the set of fourth substrate markings form the game boundary corners of the simulated game court boundary.

8. The polar boundary marking system of claim 4, wherein the set of second substrate markings form midpoints of the first major side and the second major side.

9. The polar boundary marking system of claim 4, wherein a subset of the set of first substrate markings form midpoints of the first minor side and the second minor side.

10. The polar boundary marking system of claim 4, wherein the set of first substrate markings comprises a collinear alignment, wherein the origin bisects the set of first substrate markings.

11. The polar boundary marking system of claim 4, wherein the upper service area portion and the lower service area portion are each formed by subsets of the set of first substrate markings, the set of third substrate markings, and the set of fourth substrate markings.

12. The polar boundary marking system of claim 4, wherein the upper non-volley zone portion and the lower non-volley zone portion are formed by subsets of the set of first substrate markings, the set of second substrate markings, and the set of third substrate markings.

13. A court boundary stencil, comprising:
a stencil periphery having a first major side, a second major side opposite the first major side, a first minor side, and a second minor side opposite the first minor side, the stencil periphery further comprising a first corner formed by an intersection of the first major side and the first minor side, a second corner formed by an intersection of the second major side and the first minor side, a third corner formed by an intersection of the second major side and the second minor side, and a fourth corner formed by an intersection of the first major side and the second minor side, the stencil periphery further comprising a longitudinal upper half and a longitudinal lower half;
a first diagonal strap extending from a first terminal end to a second terminal end, wherein the first diagonal strap couples to the second corner and the fourth corner;
a second diagonal strap extending from a third terminal end to a fourth terminal end, wherein the second diagonal strap couples to the first corner and the third corner, wherein the strap diagonal strap is coupled to the strap diagonal strap at a stencil center; and
a plurality of indicators disposed on the stencil periphery comprising:
a first upper non-volley indicator disposed on the first major side at the longitudinal upper half,
a second upper non-volley indicator disposed on the second major side at the longitudinal upper half, wherein the second upper non-volley indicator and the first upper non-volley indicator are equally distanced from the first minor side,
a first center indicator disposed at a midpoint of the first minor side,
a first lower non-volley indicator disposed on the first major side at the longitudinal lower half,
a second lower non-volley indicator disposed on the second major side at the longitudinal lower half, wherein the second lower non-volley indicator and the first lower non-volley indicator are equally distanced from the second minor side, and
a second center indicator disposed at a midpoint of the second minor side.

14. The court boundary stencil of claim 13, wherein the first terminal end and the second terminal end each extend beyond the second corner and the fourth corner, respectively, such that the second corner and the fourth corner are each disposed between the first terminal end and the second terminal end.

15. The court boundary stencil of claim 14, wherein the third terminal end and the fourth terminal end each extend beyond the first corner and the third corner, respectively, such that the first corner and the third corner are each disposed between the third terminal end and the fourth terminal end.

16. The court boundary stencil of claim 13, wherein the first through fourth terminal ends each comprise a grommet.

17. A court boundary stencil, comprising:
a stencil periphery having a first major side, a second major side opposite the first major side, a first minor side, and a second minor side opposite the first minor side, the stencil periphery further comprising a longitudinal upper half and a longitudinal lower half partitioned by a stencil center;
a first non-volley boundary strap coupled to each of the first major side and the second major side at the longitudinal upper half;
a first center boundary strap coupled to both a midpoint of the first minor side and a midpoint of the first non-volley boundary strap;
a second non-volley boundary strap coupled to each of the first major side and the second major side at the longitudinal lower half;
a second center boundary strap coupled to both a midpoint of the second minor side and a midpoint of the second non-volley boundary strap;
a central strap coupled to each of the midpoint of the first non-volley boundary strap and the midpoint of the second non-volley boundary strap.

18. The court boundary stencil of claim 17, wherein the central support strap is parallel with the first major side and the second major side.

19. The court boundary stencil of claim 17, further comprising a plurality of anchor straps coupled to and extending away from the stencil periphery.

20. The court boundary stencil of claim 19, wherein each of the plurality of anchor straps comprises at least one grommet.
